(19) United States
(12) Patent Application Publication
(10) Pub. No.: US 2009/0199910 A1
(43) Pub. Date: Aug. 13, 2009

(54) Robust water level control valve

(76) Inventor: William Garry Brown, Genola, UT (US)

Correspondence Address: EVERETT D. ROBINSON;Echelon IP, LLC, P.O. Box 1047, American Fork, UT, 84003-1047, US

(21) Appl. No.: 12/189,031

(22) Filed: Aug. 8, 2008

Related U.S. Application Data
(60) Provisional application No. 61/027,035, filed on Feb. 7, 2008.

(51) Int. Cl. F16K 31/18

(52) U.S. Cl. 137/409

(57) ABSTRACT

Disclosed herein are water control devices having a normally closed valve preventing water flow upon breakage of an outer mechanism having a float weight, that float weight overcoming the resistance of the valve under conditions of non-contact with water, that submerged float weight reducing in apparent weight as seen by the valve actuator. A float weight may be made from a material with about the same density as water, or with heavier materials with voids or pockets having an overall density of water or a substantial density greater than that of air. A control mechanism may be provided that moves independently of the valve, providing for decoupling of the float weight from the valve if the float weight is forced out of position. Detailed information on various example embodiments of the inventions are provided in the Detailed Description below, and the inventions are defined by the appended claims.

### CROSS-REFERENCE TO RELATED APPLICATIONS

This application claims the benefit of U.S. Provisional Patent Application No. 61/027,035 filed Feb. 7, 2008, which is hereby incorporated by reference in its entirety.

### BACKGROUND

The claimed systems and methods relate generally to automatic water level control valves, and more particularly to those valves that include a normally-closed valve and a float weight that diminishes its apparent weight when submersed in water.

Depicted in FIG. 1A are the elements of an ordinary float valve used to control the level of water inside a tank, such as a toilet tank. That valve includes a stopper 7 riding in a mounting 6 between an open and closed position, the open position shown in FIG. 1A. In the open position, a gap is maintained between stopper 7 and inlet pipe 8 through which gap water is allowed to flow as indicated by the arrows. Inlet pipe 8 contains a continuous pressurized stream of water.

The end of stopper 7 extends beyond the confines of mounting 6 whereby contact may be made to adjustment screw 1, which screw is mounted in a control arm 2 mounted to pivot on pin 3. A float 5 is mounted to a lever arm 4 which is in turn connected to control arm 2. In the state shown in FIG. 1A the level of water in the surrounding tank is sufficiently low that float 5 does not make contact. In that state, neither adjustment screw 1 nor control arm 2 makes contact with stopper 6.

As water continues to flow through inlet pipe 8 and into the surrounding tank, the level of water rises also raising float 5. Eventually, assuming that no water escapes the tank, the level of water will rise to the steady-state shown in FIG. 1B. In that state, float 5 applies an upward pressure on control arm 2 through lever arm 4, causing a downward force to be exerted on stopper six against the pressure of water in inlet pipe 8. Because there is no gap between stopper 7 and inlet pipe 8, in theory no further water flows provided that there is an effective seal.

The ordinary float valve control systems are well adapted for mild and temperate environments such as might be experienced in a house. However, when these systems are brought into outdoor or livestock environments a number of problems may be experienced. In one of these problems, a tank may be exposed to rain or other precipitation, thereby causing the water level to exceed the steady-state level. An ordinary float valve system may be designed to accommodate that, particularly by designing a control arm 2 to withstand the force imposed by the buoyancy of the float valve 5 even though it may become submerged. Now referring to FIG. 1C, if water 9 is subjected to freezing temperatures, it may be that a layer of ice 10 will form on the surface of water 9. If the ice 10 is sufficiently thick, it may prevent float 5 from breaking through. If the level of water 9 is raised, through precipitation for example, the level of ice 10 will also be raised and will cause float 5 to exert pressure on control arm 2. As control arm has reached the limit of its movement due to contact between screw 1, stopper 7 and inlet pipe 8, it will become stressed and will eventually break. If control arm 2 breaks, the pressure on stopper 7 is released and water will flow uncontrolled, potentially leading to an overflow of the surrounding tank and further damage.

### BRIEF SUMMARY

Disclosed herein are water control devices having a normally closed valve preventing water flow upon breakage of an outer mechanism having a float weight, that float weight overcoming the resistance of the valve under conditions of non-contact with water, that submerged float weight reducing in apparent weight as seen by the valve actuator. A float weight may be made from a material with about the same density as water, or with heavier materials with voids or pockets having an overall density of water or a substantial density greater than that of air. A control mechanism may be provided that moves independently of the valve, providing for decoupling of the float weight from the valve if the float weight is forced out of position. Detailed information on various example embodiments of the inventions are provided in the Detailed Description below, and the inventions are defined by the appended claims.

### BRIEF DESCRIPTION OF THE DRAWINGS

FIG. 1A shows a conventional float valve in a filling state.

FIG. 1B shows a conventional float valve in a full state.

FIG. 1C shows a conventional float valve in a stressed or broken state.

FIG. 2A presents a cross-sectional view of a first exemplary float-weight water control valve.

FIG. 2B depicts the first exemplary float-weight water control valve in perspective.

FIG. 3A shows in cross-section an exemplary normally-closed water valve in a closed state.

FIG. 3B shows in cross-section an exemplary normally-closed water valve in an open state.

FIG. 4 depicts a second exemplary normally-closed valve in its open and closed states.

FIG. 5A shows in perspective a second exemplary and compact water level controller having a lower-mounted float.

FIG. 5B depicts the second exemplary water level controller having a lower-mounted float.

FIG. 5C shows from the side a third exemplary water level controller having a lower-mounted float.

FIG. 5D shows in cross-section the third exemplary water level controller having a lower-mounted float.

FIG. 6A shows in perspective a fourth exemplary water level controller having a laterally-mounted float.

FIG. 6B shows in cross-section the fourth exemplary water level controller having a laterally-mounted float.

FIG. 6C shows in close cross-section the valve portion of the fourth exemplary water level controller.

FIG. 7 shows in cross-section a fifth exemplary water level controller having a post-chamber, transfer rod and exit tubes.

FIG. 8 depicts a sixth exemplary water level controller with a lower-mounted float weight suspended from a flexible chain link.

FIG. 9A shows in cross-section a seventh exemplary water level controller having a post-chamber, a transfer rod and exit tubes.

FIG. 9B shows in perspective and cross-section the seventh exemplary water level controller.

FIG. 9C shows in perspective the seventh exemplary water level controller from the side.

FIG. 9D shows in perspective the seventh exemplary water level controller in an offset front view.

FIG. 10 shows an exemplary arrangement of a horizontally mounted valve linked through two arms.

FIG. 11 shows an exemplary arrangement of a vertically mounted valve linked through a pivoted arm.

FIG. 12 shows an exemplary arrangement of a horizontally mounted valve linked through a pivoted arm.

FIG. 13A shows in cross-section an exemplary one-piece valve body in an open state.

FIG. 13B shows in cross-section the exemplary one-piece valve body in a closed state.

FIG. 14 depicts a water level controller having a ball-shaped float weight with a flexible linkage.

FIG. 15 depicts a water level controller having a ball-shaped float weight with a flexible linkage and an upwardly-directed arm.

FIG. 16 depicts a water level controller having downwardly-directed a fixed float weight.

FIG. 17 depicts a water level controller having upwardly-directed a fixed float weight.

Reference will now be made in detail to particular implementations of the various inventions described herein in their various aspects, examples of which are illustrated in the accompanying drawings and in the detailed description below.

### DETAILED DESCRIPTION

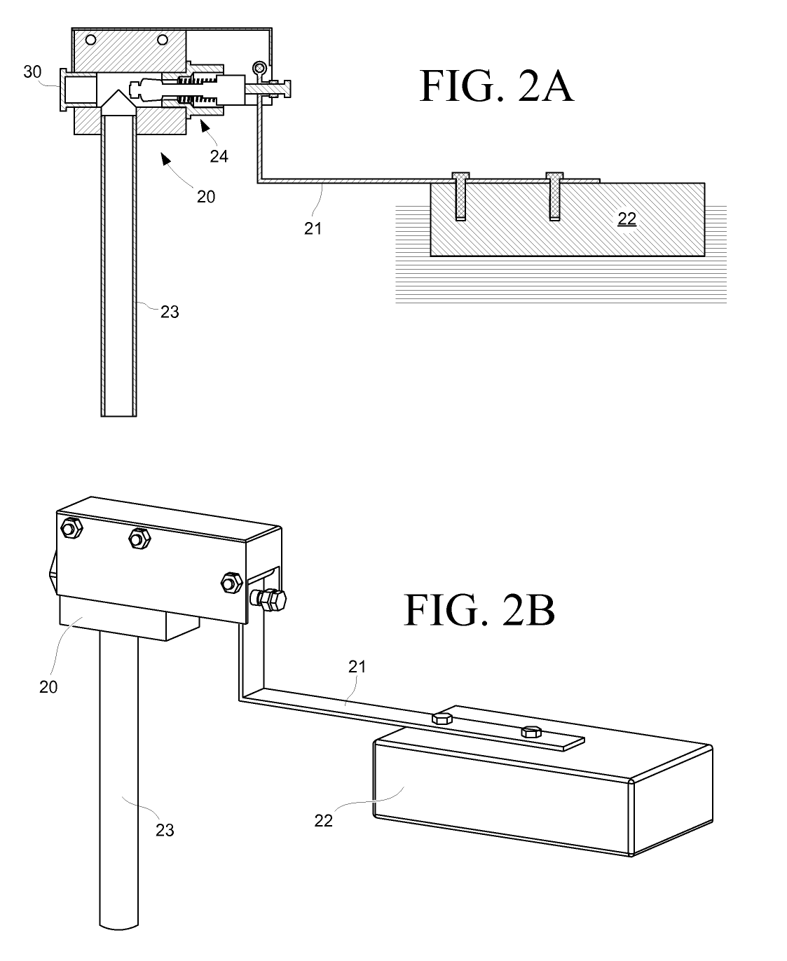

An exemplary water level control system is displayed in FIG. 2B and in cross-section in FIG. 2A. The system includes a valve body 20, an inlet pipe 23 and an arm 21 to which is attached a buoyant weight 22. Valve body 20, in this example, is formed of machined cast iron having a first and second bore. In the first bore is mounted a valve 24 and a plug 30 sealing the opposite end of the first bore. Valve 24 and plug 30 are formed of plastic in the example, and mount into the first bore by way of threads formed in each of body 20, valve 24 and plug 30. In this and other examples a valve body, a valve or a plug may be formed of other materials such as brass, aluminum, plastics, composites, etc., and may be coupled together through many methods such as welding, glues, etc., so long as these materials and coupling methods withstand the internal water pressure provided. A second bore is formed perpendicular to the first allowing for the attachment of inlet pipe 23, forming a channel between the inlet pipe 23 and the valve 24 through which water may flow where valve 24 is in an open state.

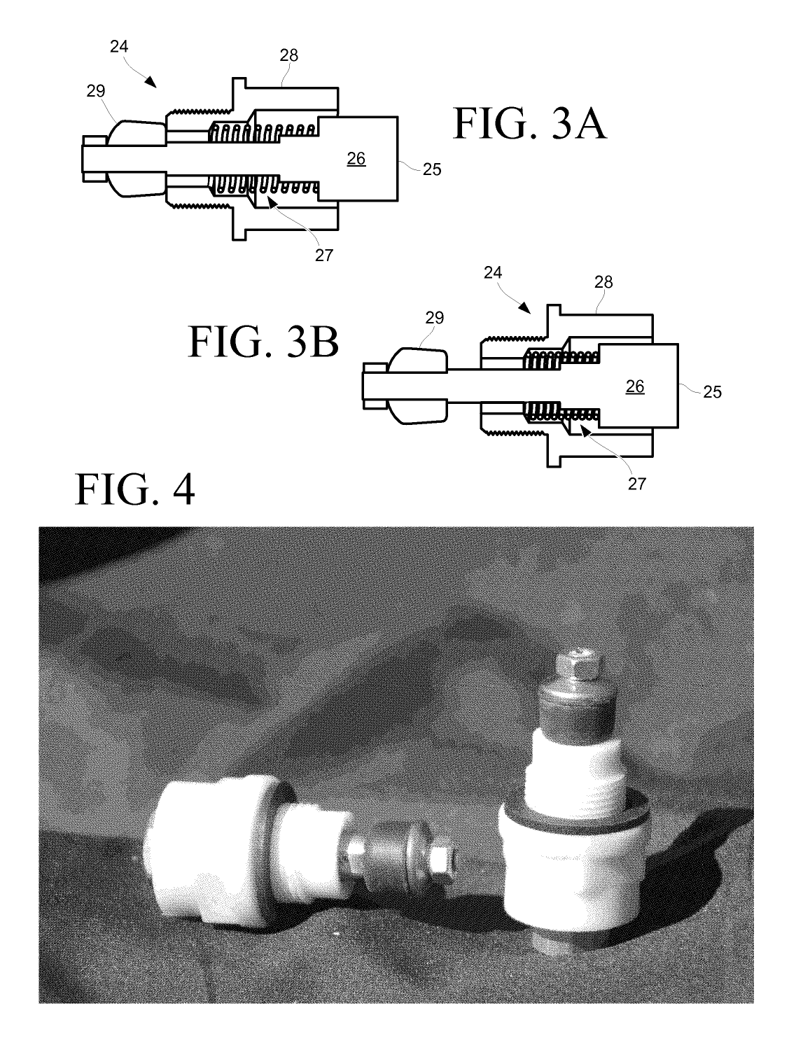

Now referring to FIG. 3A, the components of exemplary valve 24 are more easily seen. A valve housing body 28 includes a bore into which is inserted an articulating portion 26. A return spring 27 provides a return force for articulating portion 26 to the position shown in FIG. 3A. A rubber stop 29 seals against the end of housing 28 thereby providing a blockage against fluids through its inner passages. A contact surface 25 provides a surface upon which a pressure may be applied against return spring 27, whereupon under such force articulating portion 26 moves inwardly. In doing so, stop 29 is moved away from housing 28 providing a gap in allowing for the passage of fluids through the inner bore as shown in FIG. 3B. The valve shown in FIGS. 3A and 3B is merely one exemplary valve that can be used; other valves having an actuator and configured to be normally-closed may provide usable substitutes. In the example and as shown in FIG. 4, housing 24 may be formed of molded plastic and actuator 26 is formed of machined brass, however other materials can be used selected for cost, ease of manufacturing, resistance to liquids controlled, service life, and other factors as desired.

Now returning to FIGS. 2A and 2B, in the exemplary float valve arm 21 angularly moves about a pivot 30 whereby a screw 31, mounted to arm 21, may be brought into contact with surface 25. At the far end of arm 21 is mounted a buoyant weight 22, in this example through a bolt-and-thread arrangement. A downward force of weight 22 produces a force applied by screw 31 to contact surface 25, thus causing spring 27 to be compressed and valve 24 to open. As shown in FIG. 2A, weight 22 may be partially submerged in water 9 or another liquid. This produces a buoyancy of weight 22, reducing the force applied by screw 31 on surface 25 allowing valve 24 to return to its normally closed position as shown. The effective fill level depends on the buoyancy of weight 22 and the force applied by spring 27; less buoyant materials in weight 22 and stronger springs 27 will cause the fill water level to rise.

In the example arm 21 and screw 31 are formed of steel, and weight 22 is formed of a high-density polyethylene (HDPE) with a specific gravity of about 0.955. However, other materials and configurations may be used. For example, arm 21 may be replaced by a rod or other extensional member, or by another structure whereby a force may be applied to a valve under conditions of float buoyancy. In another example, an arm is not attached by a pivot, but rather a flexible hinge attached to an arm. In yet another example, the arm itself is flexible and forms an effective hinge. Likewise other substitutions may be made in keeping with the principles and operation disclosed herein. Shown in FIG. 16 is an alternate construction, wherein arm 21 includes a guard surrounding the area around actuator 26, providing further protection.

Hereinafter other examples will be described that include a float that has a density of about that of water. Thus, when the float is not immersed it has a substantial weight of about that at the same volume of water. This weight may be used to overcome the bias in a normally-closed valve by way of arms, linkages and control mechanisms as described herein in the first example and otherwise. When the float is introduced to water, its weight is reduced as seen by the arm or other control mechanism and, because the density is about that of water, the weight of the float is supported by the buoyancy of the float and not substantially by the linkage. Other floats may not have a density the same as water, but differ from its hollow counterparts in common use in that it has a substantial weight sufficient to overcome the bias in a normally-closed valve. This kind of weight having a density producing a substantial weight that may optionally be near that of a fluid of application is herein referred to as a float weight because when not immersed in the fluid it appears to be a weight to connecting linkages, while at the same time acting as a level sensing device that would otherwise be identified as a float by an ordinary person on merely a visual inspection. Herein when speaking of buoyancy with respect to a float weight, that term means a reduction in weight of the float weight when immersed and does not mean that it would necessarily float in water or another liquid.

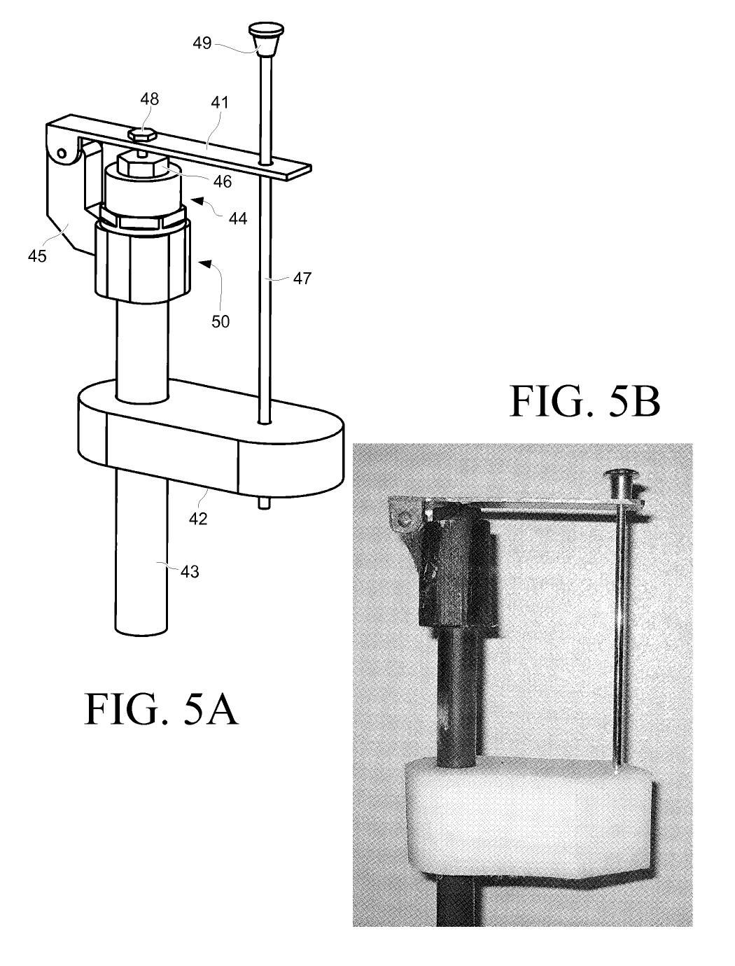

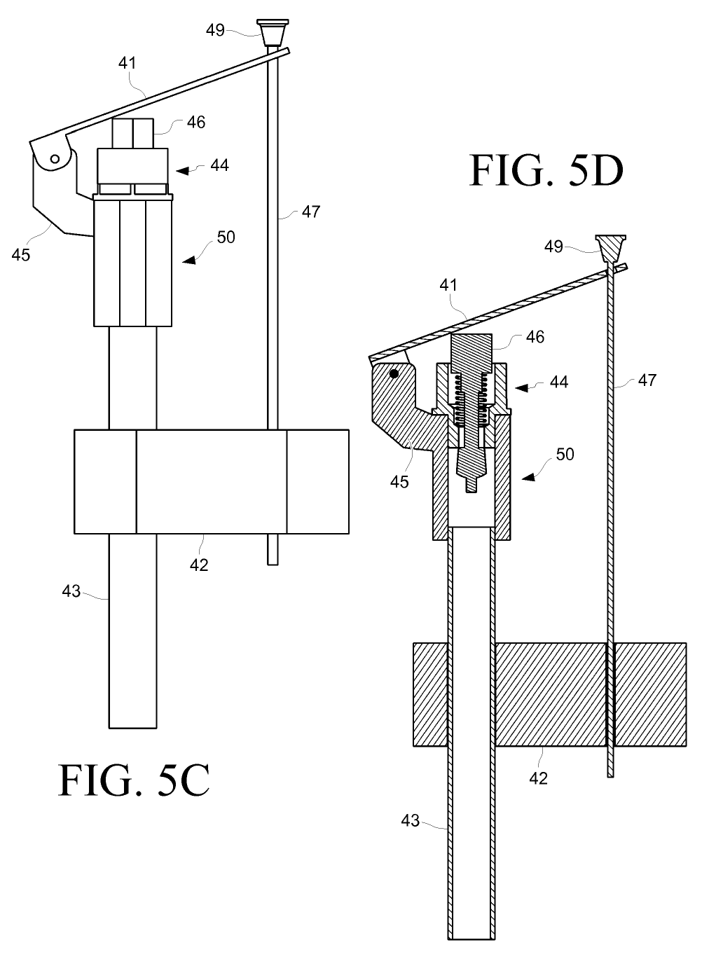

In a second example depicted in FIGS. 5A and 5B and a third example depicted in FIGS. 5C and 5D, a float valve mechanism need not include an arm that imposes an angular force produced by a float weight. These examples include an inlet pipe 43 on which is fastened a manifold 50, inside which manifold is a normally-closed valve 46. Also provided is a buoyant weight 42 guided by inlet pipe 43, to which is attached a pull rod 47. To manifold 50 is attached a solid arm 45 including a pivot. A lever arm 41 is attached on one end to the pivot, and on the other end a hole is provided through which rod 47 may pass. A cap 49 is attached to the upper end of rod 47 thus limiting the travel of rod 47 within the whole of arm 41. As weight 42 and rod 47 move down cap 49 contacts arm 41, and the weight of buoyant weight 42 is applied to valve 46. As shown in FIG. 5A, an adjustment screw 48 may be provided between lever arm 41 and valve 46. Furthermore, as water rises in a surrounding tank, the buoyancy of weight 42 increases, applying less force to lever arm 41 and correspondingly to valve 46, thus permitting valve 46 to return to its normally-closed state.

Now in the previous examples the relative position of the valve is higher than the float weight. This may be desirable for some applications, particularly where a culinary water source is used as a water supply. Thus, a design that requires that incoming water fall into a tank prevents backflow of water and correspondingly contamination. In one particular example, a fill valve as described herein is used to supply a cattle trough of water, that valve being connected to either a culinary water source or cistern that supplies multiple applications. Many domestic animals behave in a manner that does not protect the cleanliness of their water, and thus a reservoir may become contaminated with disease-causing microorganisms.

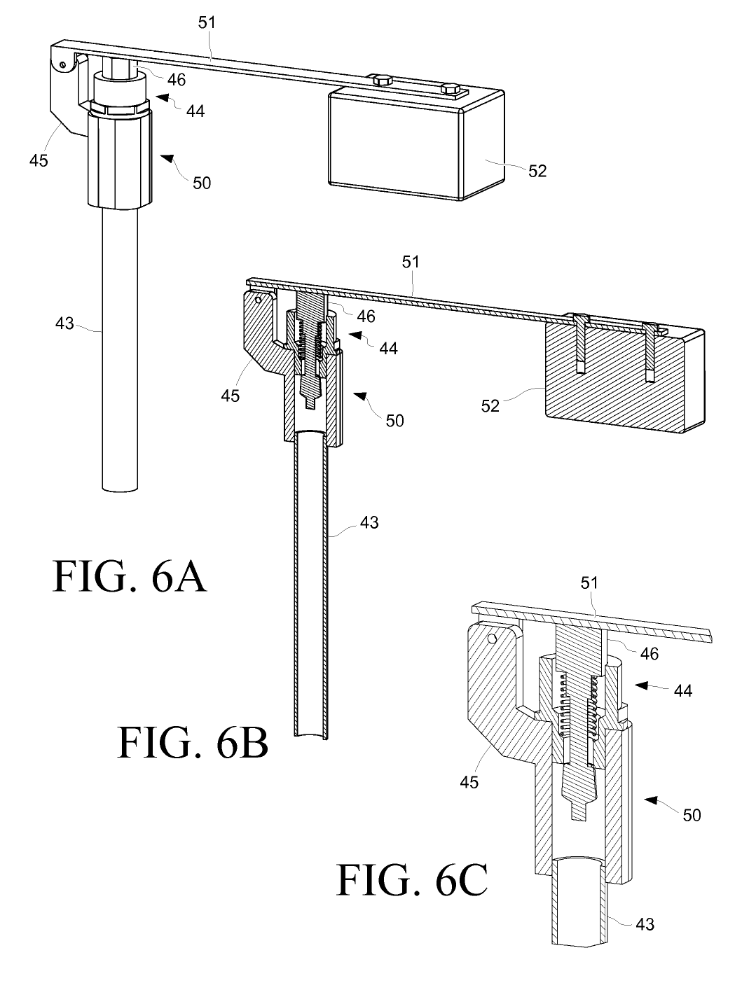

A design may be used that places a buoyant float weight and a corresponding full water level at or above a valve exhaust port, potentially discharging water without a fall. For these designs, it may be desirable to incorporate an anti-backflow valve to avoid contamination issues. Referring now to FIGS. 6A, 6B and 6C, a water filling device is shown that incorporates an inlet pipe 43, a manifold 50, a valve housing 44, a valve actuator 46, and extension arm 45 upon which a straight lever arm 51 is pivotably attached. Float weight 52 is attached to lever arm 51 opposite its pivot, here beneath lever arm 51 although another configurations weight 52 may be mounted above, to the side, etc. of lever arm 51. The float weight valve of FIGS. 6A, 6B and 6C positions a valve close to the fill level, i.e. the fill level might be set in the upper half or near the top of float weight 52. For this arrangement an anti-backflow valve would be appropriate when connected to a culinary water system.

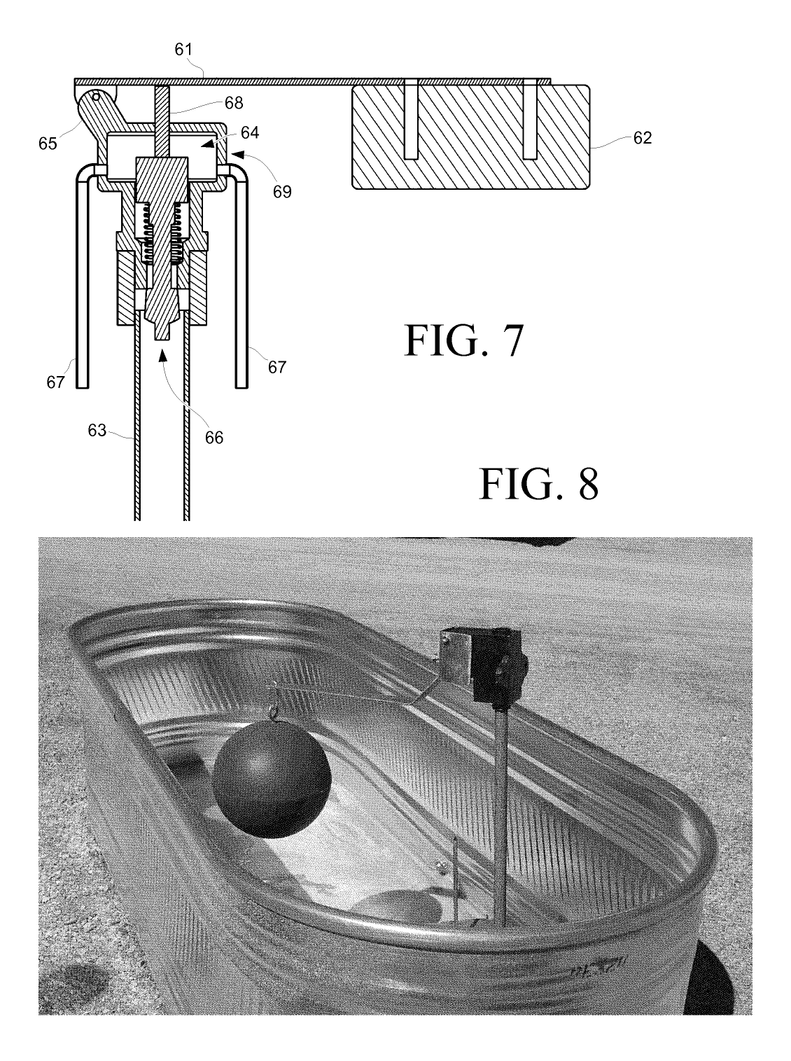

Now turning to FIG. 7, an alternate design includes an inlet pipe 63 on which is mounted a valve actuator 66 controlling the flow of water through a valve housing formed in larger housing 69. A hinged portion 65 built into housing 69 fixes one end of a lever arm 61 in position, whereupon a float weight 62 is mounted to the other end of the lever arm 61. The movement of float weight 62 download applies pressure to a transfer shaft 68, held in place by housing 69, which pressure is transferred to actuator 66 and thereby controlling the flow of water. In this example, housing 69 forms a chamber 64 having exit ports to which are attached outflow tubing members 67, the valve 66 venting water into this post-chamber. Tubing members 67 may be arranged so that water is streamed to a higher location than float weight 62, thus avoiding the problem of backflow contamination. In another arrangement, tubes 67 may be positioned for use in an ordinary toilet tank, i.e. with one tube directed into an overflow pipe and another tube positioned in the tank for filling. If two or more exit tubes are provided, they may be fashioned in different sizes to accommodate differing flow needs in the areas to which the tubes are directed. In another example, a post-chamber may be used to create pressure in one tube and a tubeless exit port may direct water to the area and immediate vicinity of the chamber.

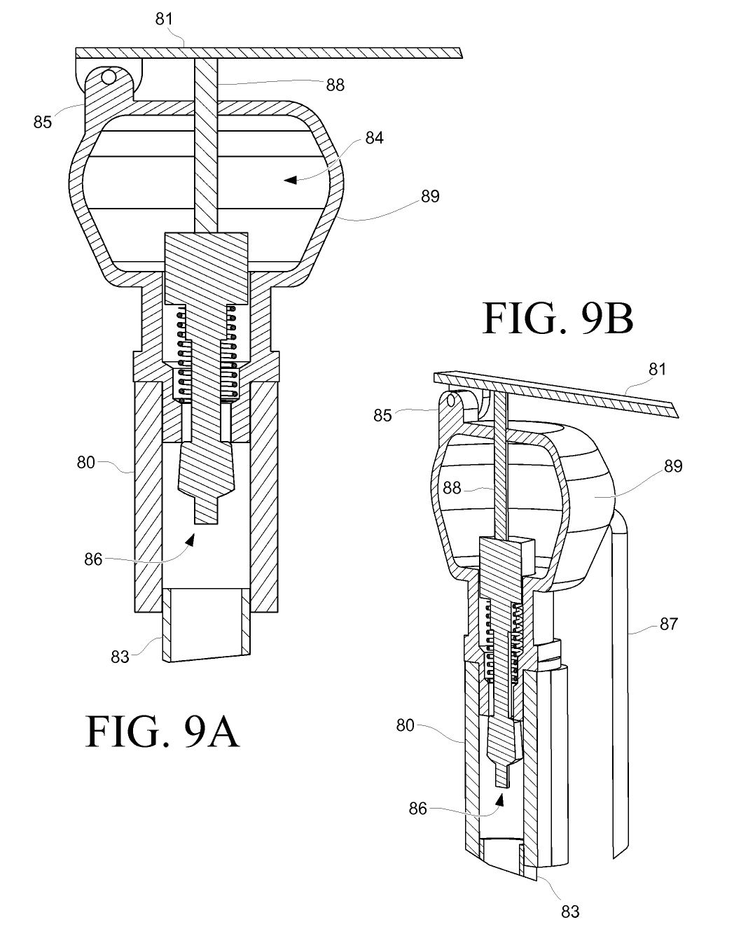

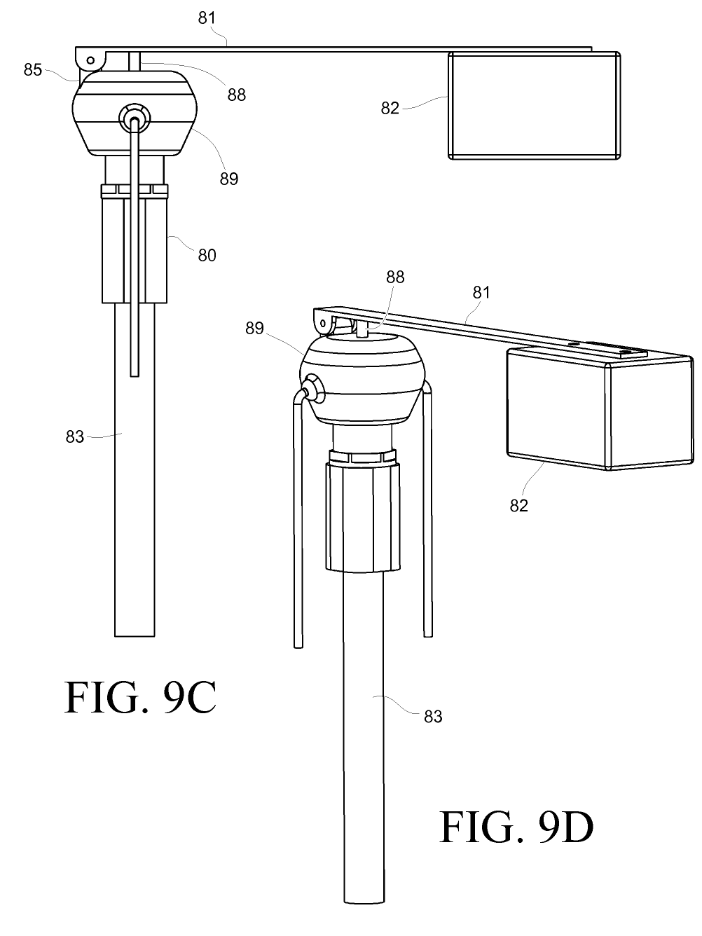

Now turning to FIGS. 9A, 9B, 9C and 9D, a valve assembly may be constructed with an outer wall containing a post-chamber that also acts as the outer wall the valve itself. Such constructions may simplify the assembly of a level controlling device and reduce the number of component parts. The level controlling assembly and coupled to an inlet pipe 83 by way of manifold section 80 that also couples to outer wall portion 89. Valve actuator 86 rides in formations constructed within outer wall 89, including seats for this spring and seal of this example. A post-chamber 84 is formed within the outer wall 89 with outflows 87 connected thereto. An arm 81 pivots about a pin mounted within protrusion 85, which arm also contacts and presses transfer shaft 88 by which a force an arm 81 is transferred through to valve actuator 86. Float weight 82 is attached to the end of arm 81 and, when the weight is not in contact with water, supplies a force to the end of arm 81 supplying a force download to transfer shaft 88 and actuator 86.

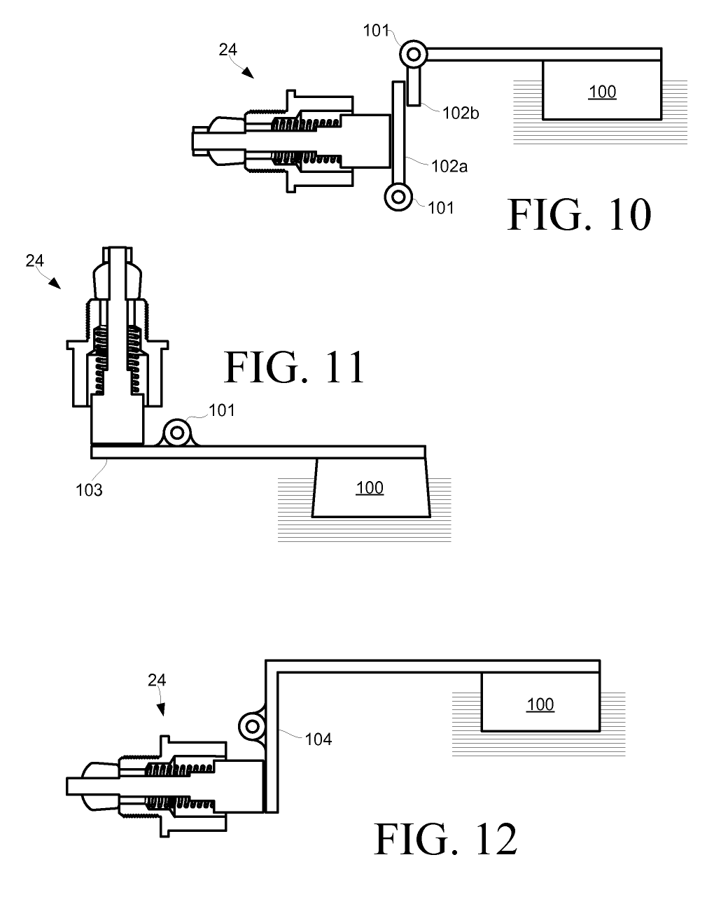

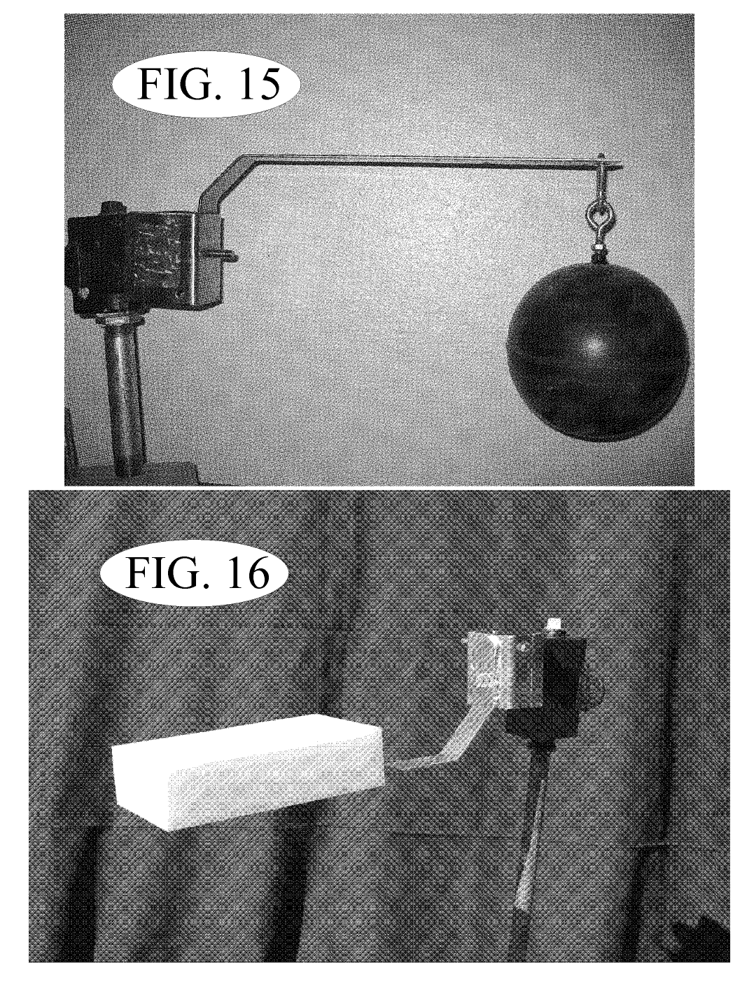

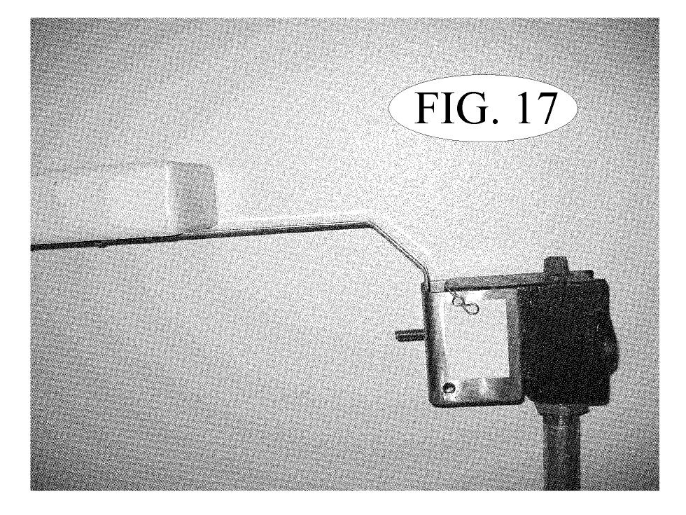

In the examples above, an arm or extensional member is used with a direct attachment to a float weight, which is the simplest arrangement. Other control mechanisms may be used. In the example of FIG. 10, two arms 102a and 102b are used to depress a valve 24. A change of direction of the force of weight 100 is accomplished through a bend at one of pivots 101, thereby permitting the valve 24 to be mounted with a side-discharge. In another example depicted in FIG. 11, a straight arm 103 is mounted to a pivot and a float weight 100, pressing on a valve in a discharge-down orientation. In yet another example depicted in FIG. 12, a valve is mounted in a side-discharge orientation with a bent arm 104 providing for change of direction of force and a float weight 100 that is potentially at a higher level than valve 24. This mounting or the mounting of FIG. 10 is suitable for the upward-arm mountings shown in FIGS. 15 and 17.

However, solid linkages are not needed with a float weight; flexible linkages may also be used. For example, the float weights of FIGS. 14 and 15 are mounted to an arm through a flexible chain linkage, permitting the weight to swing freely on an arm. By using a flexible linkage it is possible to avoid damage to a water leveling system by interference with solid objects and bumps through animals or other causes. For example, referring to the installation of FIG. 8, a cow bumping its nose against the hanging float weight from the side will not cause undue pressure to be exerted on the arm or the valve.

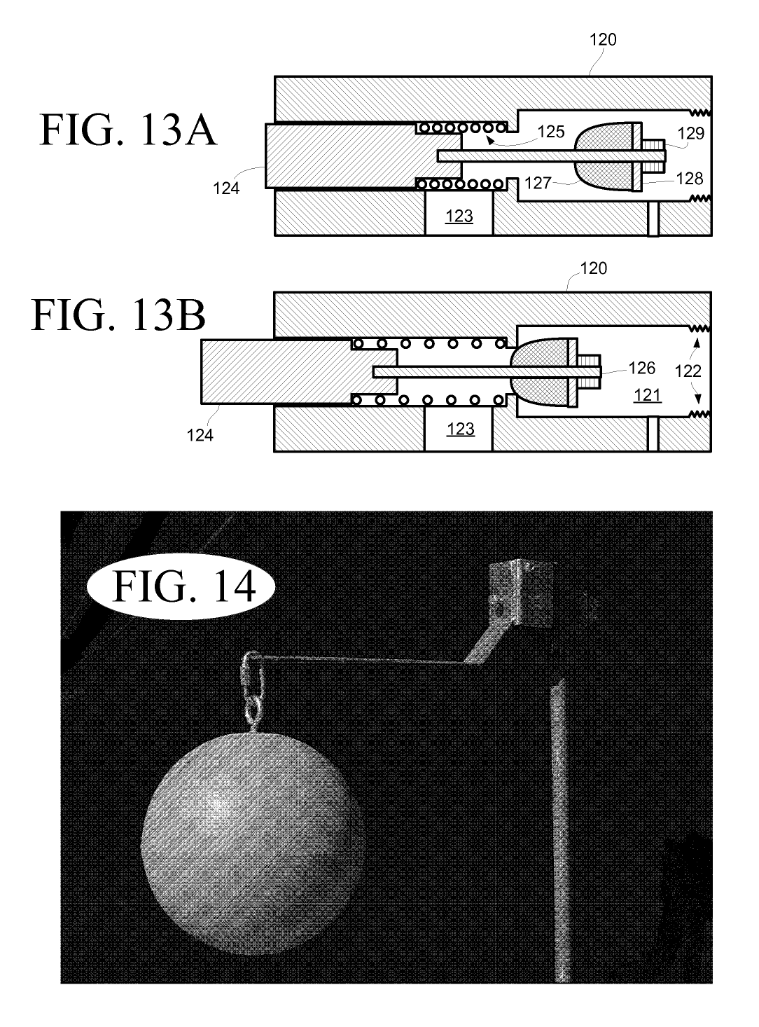

Now turning to FIGS. 13A and 13B, a one-piece valve body may be fashioned from a block of stock material now described. A housing body 120 is constructed from a sufficiently large block, which may be a plastic material such as PTFE or the like. A horizontal first bore is drilled the long way through the block having a diameter of ½ inch. On the valve end the bore is enlarged to ¾ inch diameter and on the other side the bore is enlarged for an ante-chamber 121, a center portion being left at ½ inch diameter. Threads 122 may be formed for a direct attachment for a water supply pipe, and the bore therein may be about one inch diameter. A second vertical ¾ inch bore 123 forms an exhaust port, that bore intersecting with the ¾ inch bore enlargement. A valve piston 124 is formed of a rod having a diameter slightly less than the ¾ inch diameter, which is shouldered for the receipt of a spring 125. The inner center of piston 124 is drilled and threaded for receipt of a rod 126, which rod is threaded on both ends. On rod 126 is mounted a seal 127, formed of rubber or other pliable material, secured by a washer 128 and nut 129.

In the examples above and other examples that will be apparent to the reader, some general comments apply. First, the length of an arm on which a float weight is mounted and the distance between a valve actuator and its pivot determines the lever arm of the float weight on the valve. Thus, a valve may be used having a heavy spring that requires more force to open. In that case, a longer lever arm or a heavier float weight may be used.

Float weights may be composed of many materials in many arrangements, so long as a float weight maintains a substantial opening weight for a normally-closed valve. Generally speaking, the shell-type air-filled floats available for toilet applications are not suitable because they have insufficient weight to open a valve when a water level is low. However, many other configurations and materials may be used. In the examples above a float weight is made of a solid plastic material; solid high-density polyethylene is appropriate for many applications. Although examples are described above having a density close to that of water, a less-dense material can be used if a lighter valve spring and/or a longer arm is used. Likewise, a material denser than water can be used if an appropriate spring is used that discriminates between the full, open-air weight and the lesser apparent weight of the float weight somewhat buoyed up by surrounding water. Similarly, a float weight could be constructed of a container filled with water, which may be by a shell formed of plastic, metal or other generally impermeable material. This kind of float weight might be fully enclosed or might be partially enclosed allowing for filling on submersion in a tank, such as the tank where the float will be used. If a partially enclosed float is used, a means of limiting evaporation may be employed such as a stopper or even the use of small fill-holes preventing substantial air circulation through the interior. Also, materials that are substantially heavier than water may be used, keeping in mind that voids or pockets within a float weight may reduce the density as a whole to an appropriate value.

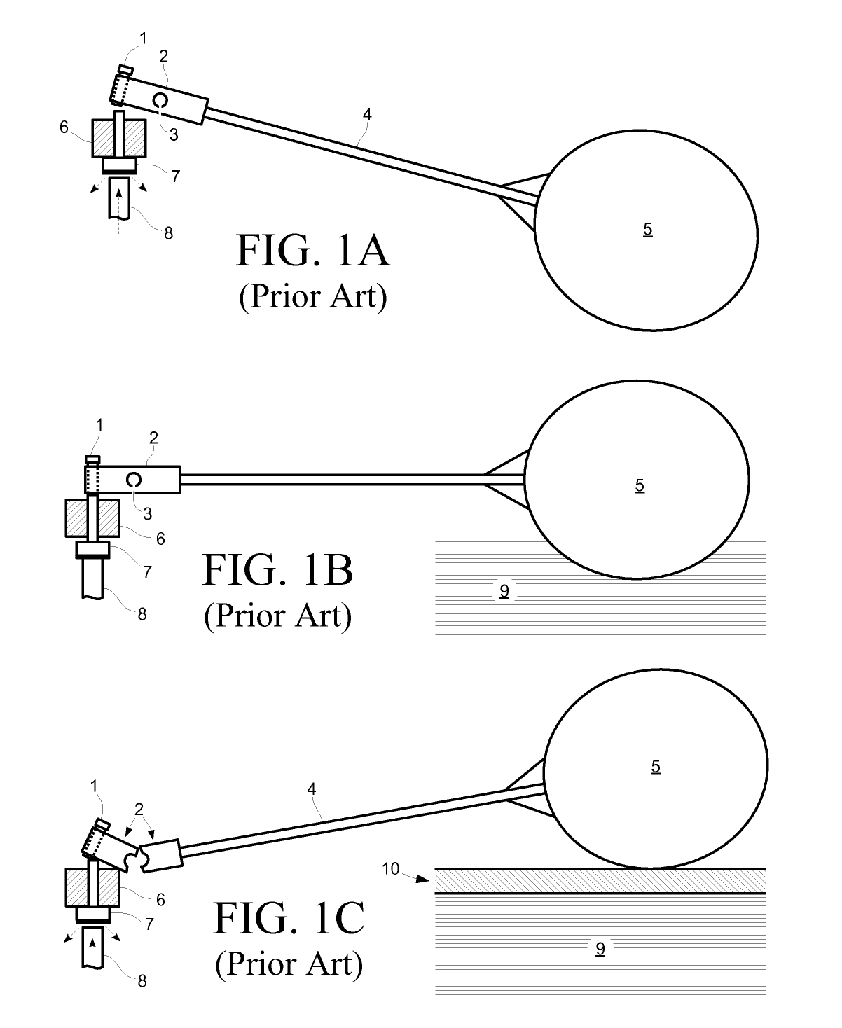

The shape of a float weight may be selected for its application of use. For example, where ice buildup is likely the sides of a float weight may be substantially vertical at the water line under full conditions. This may mitigate the condition shown in FIG. 1C, i.e. a negative slope on the bottom of the ball-like float that pushes up. A float-weight positive slope may also be used, such as that shown in FIG. 11, that presents a slope at the waterline that pushes down.

Now although certain exemplary embodiments have been described above particularly to water level control devices, one of ordinary skill in the art will recognize that the functions, principles and methods presented herein may be generalized to the control of other liquids and fluids, including alcohols, oils, gasoline, kerosene, cryo-fluids, compressed gasses, and many others. Additionally, the exact configurations described herein need not be adhered to, but rather these may be varied according to the skill of one of ordinary skill in the art. The invention, as defined by the appended claims, is to be fully embraced within its scope.

What is claimed:

1. A control valve for maintaining the level of water in a tank or cistern, comprising:
a coupling to a water supply;
a valve body, said valve body having a control surface to which force may be applied, said valve body further biased to a closed position in the absence of a force applied to said control surface, said valve body further configured to open when subjected to a force greater than or equal to a threshold force applied to said control surface in an activation direction, said valve body being coupled to said coupling to a water supply such that water passes through said valve body in its open state;
an outlet for depositing water into the tank or cistern, wherein water flowing through said valve body exits said control valve at said outlet;
a buoyant float weight having a density of about the density of water when considered as a whole;
a control arm operable within the tank or cistern and further transferring the weight of said buoyant float weight to said control surface, when in combination said buoyant float weight and said control arm are configured to define a fill level wherein a force is applied to said control surface of said valve in an amount equal to said threshold force, further wherein said buoyant float weight and said control arm are configured to apply a force to said control surface of said valve in an amount greater than said threshold force under condition of a water level in the tank or cistern lower than said fill level, said control arm having a range of positions including a range corresponding to a range of water levels within the tank or cistern at or below said fill level, said range of positions having a further range corresponding to water levels above said fill level;
wherein said control arm is configured to move independently from said valve in the portion of its range of positions corresponding to a water level above said fill level, and further wherein no substantial pressure is applied to said valve body under conditions of said buoyant float weight rising above said fill level.

2. A control valve for maintaining the level of water in a tank or cistern using a source of water from a water supply, comprising:
a valve body, said valve body having a control surface to which force may be applied, said valve body further biased to a closed position in the absence of a force applied to said control surface, said valve body further configured to open on force greater than or equal to a threshold force applied to said control surface in an activation direction;
an outlet for depositing water into the tank or cistern, wherein water flowing through said valve body exits said control valve at said outlet;
a buoyant float weight having a density of about the density of water when considered as a whole;
a control mechanism operable within the tank or cistern and further transferring the weight of said buoyant float weight to said control surface, when in combination said buoyant float weight and said control mechanism are configured to define a fill level wherein a force is applied to said control surface of said valve in an amount equal to said threshold force, further wherein said buoyant float weight and said control mechanism are configured to apply a force to said control surface of said valve in an amount greater than said threshold force under condition of a water level in the tank or cistern lower than said fill level, said control mechanism having a range of positions including a range corresponding to a range of water levels within the tank or cistern at or below said fill level, said range of positions having a further range corresponding to water levels above said fill level;
wherein said control mechanism is configured to move independently from said valve in the portion of its range of positions corresponding to a water level above said fill level, and further wherein no substantial pressure is applied to said valve body under conditions of said buoyant float weight rising above said fill level.

3. A control valve as recited in claim 2, further comprising a mounting body wherein is mounted said valve body.

4. A control valve as recited in claim 3, wherein said mounting body includes an antechamber upstream to said valve body, and further wherein said mounting body comprises a passage and a flow outlet.

5. A control valve as recited in claim 2, wherein fill level is below said outlet.

6. A control valve as recited in claim 2, wherein said buoyant float weight is rigidly mounted to said control mechanism.

7. A control valve as recited in claim 2, wherein said buoyant float weight is suspended from said control mechanism with a flexible linkage.

8. A control valve as recited in claim 2, wherein said control mechanism includes a transfer shaft in contact with said control surface.

9. A control valve as recited in claim 2, wherein said buoyant float weight has a density substantially higher than that of air.

10. A control valve as recited in claim 2, wherein said buoyant float weight comprises high-density polyethylene.

11. A control valve as recited in claim 2, wherein said buoyant float weight has a density less than that of water.

12. A control valve as recited in claim 2, wherein said buoyant float weight has a density greater than that of water.

13. A control valve as recited in claim 2, wherein said buoyant float weight contains water.

14. A control valve as recited in claim 2, wherein said buoyant float weight is solid.

15. A control valve as recited in claim 2, wherein said buoyant float weight contains pockets.

16. A control valve as recited in claim 2, wherein the contact surfaces of said buoyant float weight at the full water line are substantially vertical.

17. A control valve as recited in claim 2, wherein the contact surfaces of said buoyant float weight at the full water line bear a positive slope.

18. A control valve as recited in claim 2, wherein said control mechanism and said buoyant float weight are configured such that at the fill level the water line meets said buoyant float weight in its upper half.

19. A control valve as recited in claim 2, further comprising a post-chamber downstream to said valve body, and wherein said control valve further comprises an outflow tubing member configured to receive water from said post-chamber.

20. A self-filling and leveling container incorporating a control valve for maintaining the level of a fluid material, the control valve incorporating a float weight, comprising:
a container configured to contain a quantity of the fluid material;
a coupling to a supply of the fluid material;
a valve body, said valve body having a control surface to which force may be applied, said valve body further biased to a closed position in the absence of a force applied to said control surface, said valve body further configured to open on force greater than or equal to a threshold force applied to said control surface in an activation direction;
an outlet for depositing the fluid material into the tank or cistern, wherein fluid material flowing through said valve body exits said control valve at said outlet;
a buoyant float weight having a density of about the density of the fluid material when considered as a whole;
a control mechanism operable within the tank or cistern and further transferring the weight of said buoyant float weight to said control surface, when in combination said buoyant float weight and said control mechanism are configured to define a fill level wherein a force is applied to said control surface of said valve in an amount equal to said threshold force, further wherein said buoyant float weight and said control mechanism are configured to apply a force to said control surface of said valve in an amount greater than said threshold force under condition of a level of the fluid material in the tank or cistern lower than said fill level, said control mechanism having a range of positions including a range corresponding to a range of levels within the tank or cistern at or below said fill level, said range of positions having a further range corresponding to levels of fluid material above said fill level;
wherein said control mechanism is configured to move independently from said valve in the portion of its range of positions corresponding to a level of fluid material above said fill level, and further wherein no substantial pressure is applied to said valve body under conditions of said buoyant float weight rising above said fill level.
